(19) United States
(12) Patent Application Publication
(10) Pub. No.: US 2002/0122378 A1
(43) Pub. Date: Sep. 5, 2002

(54) RECORDING MEDIUM WITH INDEX PRINT AND METHOD FOR PRODUCING THE SAME

(76) Inventor: MASAHIRO KUBO, KANAGAWA (JP)

Correspondence Address: SUGHRUE MION ZINN MACPEAK AND SEAS, 2100 PENNSYLVANIA AVENUE NW, WASHINGTON, DC, 200373202

(21) Appl. No.: 09/136,619

(22) Filed: Aug. 20, 1998

(30) Foreign Application Priority Data
Sep. 10, 1997 (JP) 9-245473

(51) Int. Cl. G11B 3/70; G11B 5/84; G11B 7/26

(52) U.S. Cl. 369/273

(57) ABSTRACT

In recording digital image data onto a CD, original images of the recorded digital image data are printed directly onto a surface of the CD to make the CD have a function equivalent to that of a conventional index print. The image recording medium and the index print are not separated.

### BACKGROUND OF THE INVENTION

1. Field of the Invention

The present invention relates to a recording medium with an index print having index information added to a recording medium in the form of a disk having a digital data recording surface on which a plurality of digital image data can be recorded, and a method for producing this recording medium.

2. Description of the Related Art

Conventionally, a photographic film (hereinafter to be referred to as a negative film) which has been exposed by a camera is developed and optically print-exposed onto a photo-sensitive material (photographic printing paper) at a predetermined magnification factor in a photographic laboratory, and then this photographic printing paper is developed and returned to a customer together with the negative film.

A customer can order an additional prints or the like by relating an image on the returned photographic printing paper to an image on the negative film.

In recent years, there has been an increasing demand for obtaining digital image data of an image photographed by a camera, along with the spread of personal computers. To meet this demand, photographic laboratories are scanning an image on a negative film to prepare digital image data, recording this digital image data on a recording medium such as a CD (compact disk) or a DVD (digital video disk) and providing the recorded recording medium to customers. With this arrangement, customers can load this digital image data into their own personal computers to carry out suitable image processing and print out an image.

However, this recording medium is only recorded with the digital image data, and a customer cannot confirm visually the contents of the recording medium. To overcome this difficulty, an index print is provided together with this recording medium. However, as the recording medium and the index print are separate units, it becomes difficult to collate these or it takes time for the collation if the recording medium and the index are kept separately.

### SUMMARY OF THE INVENTION

Taking the above facts into consideration, it is an object of the present invention to provide a recording medium with an index print which makes it possible to recognize easily the contents of the recording medium and which can avoid the work of collation or the like when this recording medium recorded with digital image data is provided to a customer, and a method for producing this recording medium.

A first aspect of the present invention is that in a recording medium in the form of a disk having a digital data recording surface on which a plurality of digital image data can be recorded, images corresponding to the digital image data are displayed in printing on the surface opposite to the digital data recording surface.

According to the first aspect of the invention, as digital image data and a print display based on the digital image data are provided in one recording medium, the digital image data and the print display are not kept separately and this eliminates the need for collation. Further, a user (such as a customer) can visually confirm the contents of the recording.

A second aspect of the present invention is that markings for specifying images corresponding to the print images are displayed together with the print images.

According to the second aspect of the invention, when images on a photographic film are recorded as digital image data, frame numbers are provided corresponding to the digital image data, and therefore, these frame numbers when used as markings for specifying the images and displayed together with the image print display facilitate retrieval of the images.

A third aspect of the present invention is that, in either the first aspect or the second aspect, the print images are directly displayed in printing on the surface opposite to the digital data recording surface.

A fourth aspect of the present invention is that, in either the first aspect or the second aspect, after the print images are displayed in printing on a recording medium in the form of a thin sheet, the print images are affixed to the surface opposite to the digital data recording surface.

The third aspect and the fourth aspect of the invention show embodiments of the print display, and each of these aspects has advantages and disadvantages.

While a print display can be easily made directly by an ink jet system or a thermal transfer system, the print display is insufficient if there are changes (additions or the like) to the digital image data.

On the other hand, if the images are affixed after being displayed in printing on a recording material in the form of a thin sheet (a transparent film, for example) as a separate unit, then it becomes possible to reaffix the recording material. However, there is a risk of the images not being able to be read with a great degree of accuracy if any change in the balance of the recording medium should arise caused by the affixing of the separate recording material.

In any case, it is acceptable if the print display of the images is integrated into the recording medium as a result of taking measure such as the securing of an additional area or affixing an extremely thin sheet material not affecting the balance. For example, if the recording media are kept individually in a transparent case, it is possible to find the desired recording medium from the outside of the transparent case.

A fifth aspect of the present invention is a method for producing a recording medium with an index print in any one of the first aspect to the fourth aspect of the present invention, comprising the steps of recording input digital image data on one digital data recording surface, converting images expressed by the digital image data into images of a predetermined magnification factor, and displaying the converted images in printing on an opposite surface to the digital data recording surface.

According to the fifth aspect of the present invention, all the images can be displayed in printing by converting the images by a predetermined magnification factor according to the size of the recording medium.

The digital image data recording process and the print display process have no before and after relationship and they may be carried out at the same stage or at different stages.

A sixth aspect of the present invention is that in the fifth aspect, the digital image data is produced by scanning images recorded on a photographic film after exposure by a camera.

According to the sixth aspect of the present invention, the original images are photographed by a camera, and the digital image data is obtained by scanning the images on the photographic film after image developing processing. With this arrangement, the digital image data can be provided to customers.

A seventh aspect of the present invention is that, in the fifth aspect of the invention, when the original image data is digital image data, the digital image data is input through drivers corresponding to the respective digital image data or is input through a predetermined interface.

According to the seventh aspect of the invention, the digital image data can also be read from images photographed by a digital camera or from images already recorded on a CD, a DVD or the like. In this case, the digital image data can be input through the respective drivers. When images or the like are obtained from the internet, the images can be input through a predetermined interface.

### BRIEF DESCRIPTION OF THE DRAWINGS

FIG. 1 is a plan view of a CD with an index print relating to an embodiment of the present invention.

FIG. 2 is a schematic view of a device for producing a CD with an index print relating to an embodiment of the present invention.

FIG. 3 is a control block diagram of the device for producing a CD with an index print relating to an embodiment of the present invention.

FIG. 4 is a control flow chart for the device for producing a CD with an index print relating to an embodiment of the present invention.

### DESCRIPTION OF THE PREFERRED EMBODIMENTS

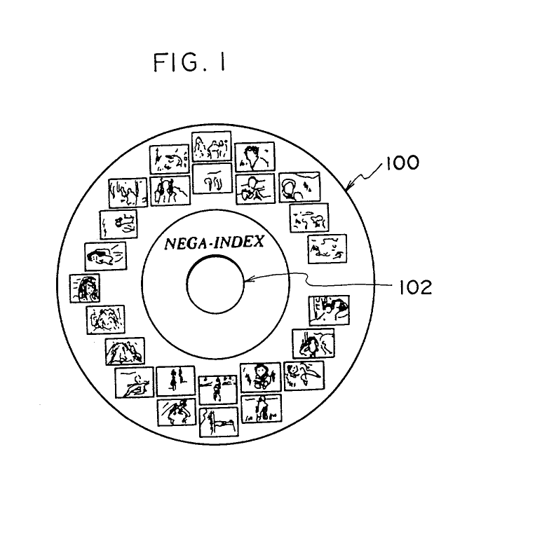

FIG. 1 shows a CD 100 as a recording medium relating to an embodiment of the present invention. The CD 100 has a donut shape and is usually rotated at a high speed around a circular hole 102 provided at the core axis, for writing and reading digital data.

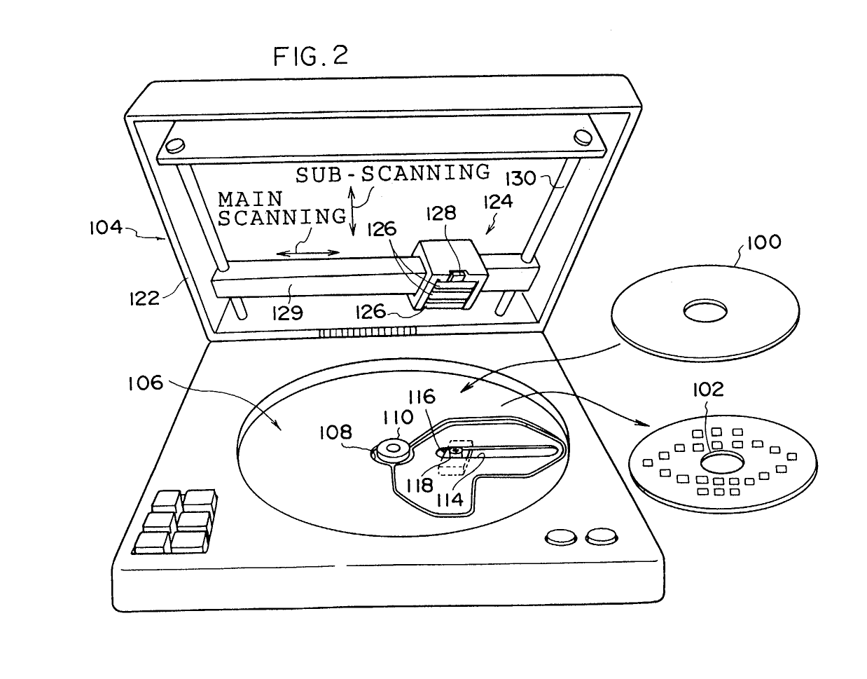

A digital data writing surface is provided on the recording surface side (the rear surface side of FIG. 1) of the CD 100, and the CD 100 is loaded into a loading section 106 of a writing device 104 shown in FIG. 2 in such a way that the recording surface faces the loading section 106.

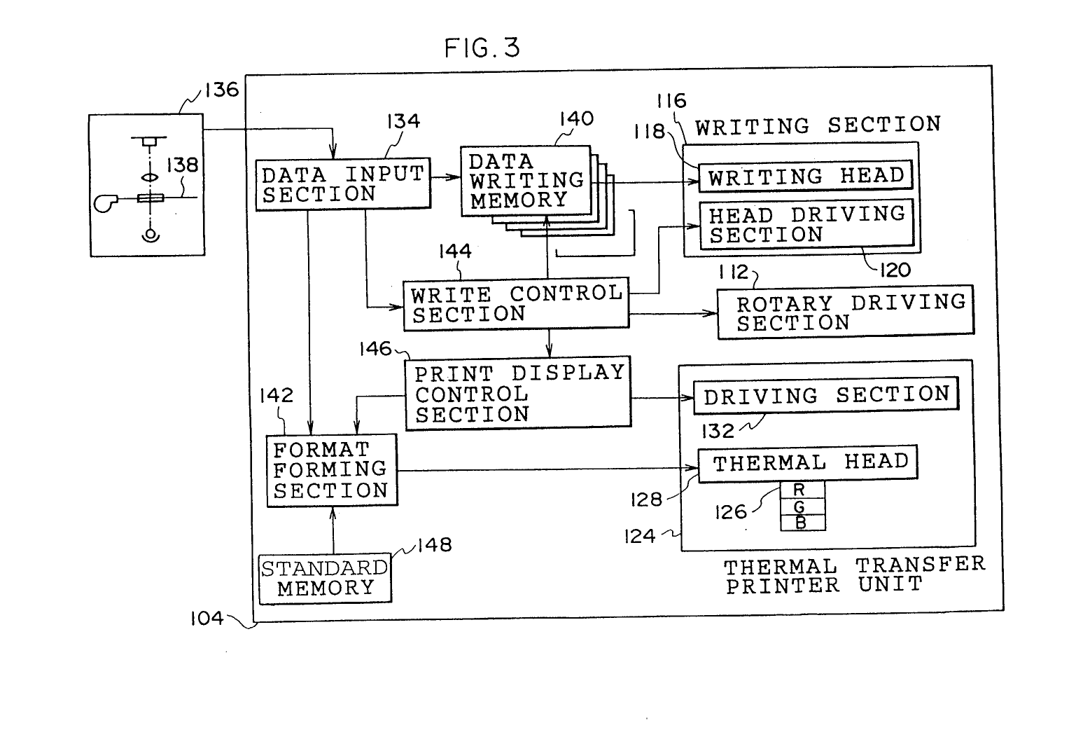

As shown in FIG. 2, a through-hole 108 is provide data bottom surface center section of the loading section 106, together with a protruding rotary axis 110 which engages with the circular hole 102. The rotary axis 110 is rotated at a high speed by a rotary driving section 112 shown in FIG. 3.

An elongated hole 114 is provided near the rotary axis 110 extending in a radial direction, and a writing section 116 is provided so as to be able to move along this elongated hole 114. The writing section 116 is constructed of a writing head 118 and a head driving section 120 for driving the writing head 118.

In a state where the CD 100 is being rotated at a high speed after being loaded into the loading section 106, the writing section 116 moves in a radial direction and digital data is recorded onto the surface of the CD 100 by the writing head 118.

The writing section 116 is provided with an openable and closable lid unit 122. The lid unit 122 incorporates a thermal transfer printer unit 124.

The thermal transfer printer unit 124 is constructed of thermal transfer ink ribbons 126 of three colors RGB and a thermal transfer thermal head 128 (hereinafter to be referred to as a thermal head 128). The thermal transfer printer unit 124 moves in such a way that while the thermal head 128 is recording one line (main scanning direction) onto the CD 100 along a base 129, the base 129 moves (sub-scanning direction) along a guide 130. The main scanning direction movement and sub-scanning direction movement are controlled by a driving section 132 (refer to FIG. 3)

When the thermal head is moved along the base 129 in the main scanning direction and the guide 130 in the sub scanning direction with the CD 100 loaded and held stationary at a predetermined rotation angle (basically the CD may be held stationary at any angle), it is able to display images on the surface of the CD 100.

FIG. 3 shows a control block diagram of the writing unit 104 and the thermal transfer printer unit 124.

Data (digital image data) of recorded images read from a negative film 138 by a scanner 136 (a separate unit in an embodiment of the present invention, but this may be integral with the writing unit 104) is input into a data input section 134.

In addition to the digital image data, frame number data is also input to the data input section 134.

The digital image data and frame number data input by the data input section 134 are stored in data writing memory 140 and is also sent to a format forming section 142.

The data writing memory 140 consists of a plurality of frame memories classified into individual image frames.

When the images from one roll of negative film 138 (or the total number of frames to be recorded on one CD 100, which is hereinafter assumed to be one roll of negative film) have been input into the data input section 134, the data input section 134 transmits a signal to the write control section 144 instructing it to write the digital image data onto the CD 100.

The write control section 144 controls the data writing memory 140, the head driving section 120 of the writing section 116 and the rotary driving section 112, to start recording of the digital image data onto the CD 100.

At the point in time when the writing of the roll of negative film 138 finishes, the write control section 144 transmits a signal to a print display control section 146.

Standard memory 148 is connected to the format forming section 142, to select a predetermined format according to the number of image frames to be input, and the addresses of individual image frames on the CD 100 are determined.

Upon receiving a signal from the write control section 144, the print display control section 146 transmits a driving signal to both the format forming section 142 and the driving section 132, and starts thermal transfer printing onto the surface of the CD 100 by controlling the thermal head 128.

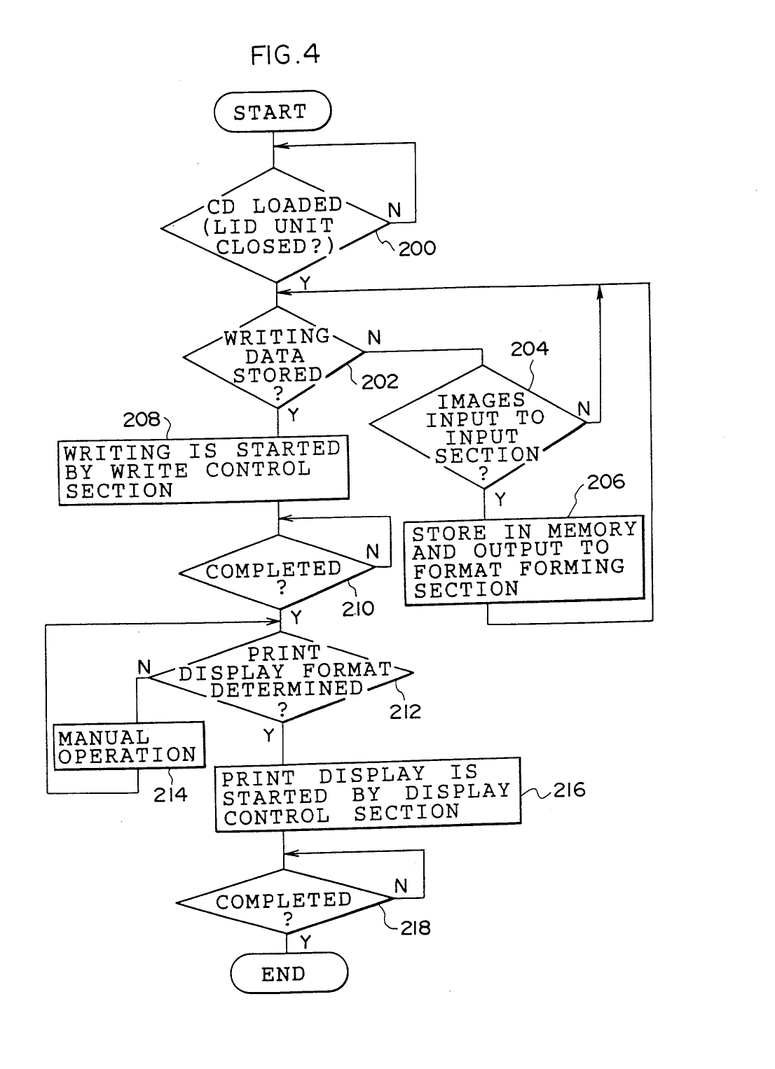

The operation of the present embodiment will be explained below with reference to the flow chart shown in FIG. 4.

At first, at step 200, a decision is made as to whether or not the CD 100 is loaded and the lid unit 122 has been closed. If a positive decision is made, a decision is made at step 202 as to whether or not data has been stored in the data writing memory 140. If a negative decision is made at this point, then the process moves to step 204 where the digital data input from the scanner 136 to the data input section 134 is awaited (during the waiting time, steps 202 and 204 are repeated).

If a positive decision is made, that is, if a decision is made that digital image data has been input at step 204, images for individual image frames are stored in the data writing memory 140 at step 206, and the process returns to step 202. In this case, a positive decision is made at step 202, and writing of the digital image data onto the recording surface of the CD 100 is started under the control of the write control section 144 at step 208.

In other words, the writing of the digital image data onto the recording surface of the CD 100 is carried out by the writing head 118 in a state where the CD 100 is being rotated at a high speed by the driving of the rotary axis 110 and where the writing head 118 is being driven in a radial direction from an axial core direction to an outer peripheral direction by the head driving section 120.

When a decision is made at step 210 that the writing has been completed, the process moves to step 212. The completion of step 210 includes the time up to when the CD 100 is halted and held in a stationary state.

At step 212, a decision is made as to whether or not the format of the images in the format forming section 142 has been determined. Usually, an APS film has about 25 frames or about 40 frames, and a 135 mm film has about 12 frames, about 24 frames, or about 36 frames. However, in certain cases, the standard formats stored in the standard memory 148 may not be applicable. In these cases, an operator may determine the format and magnification factor by a manual operation. Therefore, if a negative decision is made at step 212, a manual operation is carried out at step 214 and then the process returns to step 212.

If a positive decision is made at step 212, the thermal transfer printer unit 124 is operated by the control of the print display control section 146 and the images are printed on the surface of the CD 100 at step 216.

In other words, while image data for each line (in the main scanning direction) is being sent to the thermal head 128, the thermal head 128 is moved in the main scanning direction as well as in the sub-scanning direction by the driving section 132 (the thermal head may be driven one step in the sub-scanning direction for each single line it is driven in the main scanning direction, or it may be driven in the main scanning direction while being driven at a fixed speed in the sub-scanning direction). In this case, as the format (address) is determined in advance, the write starting position and the write ending position on each line in the main scanning direction, as well as the area which is write-protected so as to avoid the circular hole 102 are controlled automatically.

At step 218, a decision is made as to whether or not the printing (display) of the images recorded on the roll of negative film 138 has been finished, and the processing finishes if a positive decision is made.

As explained above, according to the present embodiment, in recording digital image data onto the CD 100, the CD 100 can have a function equivalent to that of a conventional index print as the recorded original images of the digital image data are displayed on the surface of the CD 100 by directly printing the images on the surface. Further, as the image recording medium and the index print are not separated, keeping and arranging them is simple and retrieval of the images is also facilitated.

Although the printing (display) of the images on the surface of the CD 100 is carried out by the thermal transfer printer unit 124 in the present embodiment, this can also be done by an ink jet printer. Further, with the surface of the CD 100 formed as a photo-sensitive layer, this may be exposed to a laser beam or the like and images may be developed.

Further, although the writing of digital image data and the printing of original images are carried out in the same stage according to the present embodiment, they may be carried out in two stages by providing separate loading sections of the CD 100.

Further, although images are printed (displayed) directly on the surface of the CD 100 according to the present embodiment, it may be so arranged that the images are printed (displayed) on a (transparent or opaque) thin sheet by a separate process and this sheet is affixed onto the CD 100.

Further, although a CD is used as a recording medium according to the present embodiment, other recording media such as a DVD or the like can also be used.

As explained above, according to the first aspect of the present invention, in providing digital image data to a customer by recording the data on a recording medium, an excellent effect is obtained in that the content can be recognized easily and collation work can be avoided.

According to the second aspect of the present invention, the images can be retrieved easily when frame numbers are displayed together with the print display of the images.

What is claimed is:

1. A recording medium with an index print wherein, in a recording medium in the form of a disk having a digital data recording surface on which a plurality of digital image data can be recorded, images corresponding to the digital image data are displayed in printing on the opposite surface to the digital data recording surface.

2. A recording medium with an index print according to claim 1, wherein markings for specifying images corresponding to the print images are displayed in printing together with the print images.

3. A recording medium with an index print according to claim 1, wherein the print images are directly displayed in printing on the surface at the opposite surface to the digital data recording surface.

4. A recording medium with an index print according to claim 2, wherein the print images are directly displayed in printing on the opposite surface to the digital data recording surface.

5. A recording medium with an index print according to claim 1, wherein after the print images are displayed in printing on a recording medium in the form of a thin sheet, the print images are affixed to the opposite surface to the digital data recording surface.

6. A recording medium with an index print according to claim 2, wherein after the print images are displayed in printing on a recording medium in the form of a thin sheet, the print images are affixed to the opposite surface to the digital data recording surface.

7. A method for producing a recording medium with an index print wherein, in a recording medium in the form of a disk having a digital data recording surface on which a plurality of digital image data can be recorded, images corresponding to the digital image data are displayed in printing on the opposite surface to the digital data recording surface, the method comprising the steps of:
recording input digital image data on one of the digital data recording surfaces; and
converting images expressed by the digital image data into images of a predetermined magnification factor, and displaying the converted images in printing on the opposite surface to the digital data recording surface.

8. A method for producing a recording medium with an index print according to claim 7, wherein
the digital image data is produced by scanning images recorded on a photographic film after exposure by a camera.

9. A method for producing a recording medium with an index print according to claim 7, wherein
when the original image data is digital image data, the digital image data is input through drivers corresponding to the respective digital image data or is input through a predetermined interface.

10. A method for producing a recording medium with an index print wherein, in a recording medium in the form of a disk having a digital data recording surface on which a plurality of digital image data can be recorded, images corresponding to the digital image data are displayed in printing on the opposite surface to the digital data recording surface and markings for specifying images corresponding to the print images are displayed in printing together with the print images, the method comprising the steps of:
recording input digital image data on one of the digital data recording surfaces; and
converting images expressed by the digital image data into images of a predetermined magnification factor, and displaying the converted images in printing on the opposite surface to the digital data recording surface.

11. A method for producing a recording medium with an index print according to claim 10, wherein
the digital image data is produced by scanning images recorded on a photographic film after exposure by a camera.

12. A method for producing a recording medium with an index print according to claim 10, wherein
when the original image data is digital image data, the digital image data is input through drivers corresponding to the respective digital image data or is input through a predetermined interface.

13. A method for producing a recording medium with an index print wherein, in a recording medium in the form of a disk having a digital data recording surface on which a plurality of digital image data can be recorded, images corresponding to the digital image data are directly displayed in printing on the opposite surface to the digital data recording surface, the method comprising the steps of:
recording input digital image data on one of the digital data recording surfaces; and
converting images expressed by the digital image data into images of a predetermined magnification factor, and displaying the converted images in printing on the opposite surface to the digital data recording surface.

14. A method for producing a recording medium with an index print according to claim 13, wherein
the digital image data is produced by scanning images recorded on a photographic film after exposure by a camera.

15. A method for producing a recording medium with an index print according to claim 13, wherein
when the original image data is digital image data, the digital image data is input through drivers corresponding to the respective digital image data or is input through a predetermined interface.

16. A method for producing a recording medium with an index print wherein, in a recording medium in the form of a disk having a digital data recording surface on which a plurality of digital image data can be recorded, images corresponding to the digital image data are directly displayed in printing on the opposite surface to the digital data recording surface and markings for specifying images corresponding to the print images are displayed in printing together with the print images, the method comprising the steps of:
recording input digital image data on one of the digital data recording surfaces; and
converting images expressed by the digital image data into images of a predetermined magnification factor, and displaying the converted images in printing on the opposite surface to the digital data recording surface.

17. A method for producing a recording medium with an index print according to claim 16, wherein
the digital image data is produced by scanning images recorded on a photographic film after exposure by a camera.

18. A method for producing a recording medium with an index print according to claim 16, wherein
when the original image data is digital image data, the digital image data is input through drivers corresponding to the respective digital image data or is input through a predetermined interface.

19. A method for producing a recording medium with an index print wherein, in a recording medium in the form of a disk having a digital data recording surface on which a plurality of digital image data can be recorded, images corresponding to the digital image data are displayed in printing on the opposite surface to the digital data recording surface, and after the print images are displayed in printing on a recording medium in the form of a thin sheet, the print images are affixed to the opposite surface to the digital data recording surface, the method comprising the steps of:
recording input digital image data on one of the digital data recording surfaces; and
converting images expressed by the digital image data into images of a predetermined magnification factor, and displaying the converted images in printing on the opposite surface to the digital data recording surface.

20. A method for producing a recording medium with an index print according to claim 19, wherein
the digital image data is produced by scanning images recorded on a photographic film after exposure by a camera.

21. A method for producing a recording medium with an index print according to claim 19, wherein
when the original image data is digital image data, the digital image data is input through drivers corresponding to the respective digital image data or is input through a predetermined interface.

22. A method for producing a recording medium with an index print wherein, in a recording medium in the form of a disk having a digital data recording surface on which a plurality of digital image data can be recorded, images corresponding to the digital image data are displayed in printing on the opposite surface to the digital data recording surface, markings for specifying images corresponding to the print images are displayed together with the print images, and after the print images are displayed in printing on a recording medium in the form of a thin sheet, the print images are affixed to the opposite surface to the digital data recording surface, the method comprising the steps of:
recording input digital image data on one of the digital data recording surfaces; and
converting images expressed by the digital image data into images of a predetermined magnification factor, and displaying the converted images in printing on the opposite surface to the digital data recording surface.

23. A method for producing a recording medium with an index print according to claim 22, wherein
the digital image data is produced by scanning images recorded on a photographic film after exposure by a camera.

24. A method for producing a recording medium with an index print according to claim 22, wherein
when the original image data is digital image data, the digital image data is input through drivers corresponding to the respective digital image data or is input through a predetermined interface.
